(19) United States
(12) Patent Application Publication
(10) Pub. No.: US 2022/0112614 A1
(43) Pub. Date: Apr. 14, 2022

(54) CONTAINER STATION FOR HYDROGEN PRODUCTION AND DISTRIBUTION

(71) Applicant: FELICITAS A-C, Kety (PL)

(72) Inventor: Radoslaw DROZDZIK, Kety (PL)

(73) Assignee: FELICITAS A-C, Kety (PL)

(21) Appl. No.: 17/428,866

(22) PCT Filed: Feb. 7, 2020
(86) PCT No.: PCT/PL2020/000012

§ 371 Date: Aug. 5, 2021

(30) Foreign Application Priority Data
Feb. 8, 2019 (PL) P.428845

(51) Int. Cl. C25B 15/08; C25B 1/04; H01M 8/0656; H01M 16/00; H01M 8/04082

(52) U.S. Cl. CPC C25B 15/08; C25B 1/04; H01M 8/04201; H01M 16/003; H01M 8/0656

(57) ABSTRACT

A container station for hydrogen production and distribution with a voltage converter, an air intake and a shutter. A fuel cell is installed inside the container. The electrolyzer is connected to the hydrogen distribution station. Hydrogen dryers, hydrogen non-return valves, a hydrogen compressor are installed on the hydrogen pressure conduit. High pressure hydrogen composite cylinders are connected to the hydrogen pressure conduit. The electrolyzer is connected to the fuel cell. Oxygen dryers, oxygen non-return valves, an oxygen compressor and oxygen solenoid valve are installed on the oxygen pressure conduit. High pressure oxygen composite cylinders are connected to the oxygen pressure conduit. The fuel cell is connected to the hydrogen pressure conduit. The inlet of central heating liquid and the outlet of central heating liquid are connected to a fluid exchanger.

### FIELD

The aspects of the disclosed embodiments relate to a container station for hydrogen production and distribution.

### BACKGROUND

Hydrogen (H₂), in particular adopted to power integrated systems in e.g. transport, construction equipment and others, is currently recognized as an energy carrier of the future instead of fossil fuels. Thus the hydrogen ensures:

solution to the problem of fossil fuel shortage;

no CO₂ emission when used to power integrated systems resulting in reduction of the impact of human activity on climate changes;

no emission of pollutants when used to power integrated systems by means of fuel cells, which significantly reduces the impact of exhaust gases on health especially in densely populated areas;

significant reduction of noise resulting from its application to power integrated systems by means of fuel cells.

However, use of the energy carrier such as hydrogen especially in case of integrated systems encounters some various difficulties.

Even though the hydrogen is present in large quantities it is not an immediately available gas. In nature, it is bound to other chemical elements that form various molecules that are usually very stable such as water, natural gas and other waste gases. Therefore, the hydrogen must be obtained from those molecules by various means. Most frequently used methods include reforming of fossil fuel and electrolysis of water.

Given the current state of the art for the application of hydrogen as a carrier for powering integrated systems, the used or currently foreseen strategies of application consist in ex situ production of hydrogen, its transport, distribution using proper infrastructure, its storage in built-in tanks and transformation into electric energy using a fuel cell or directly into mechanical energy by means of internal combustion. The relevant restrictions are related to those various operations:

since it is basically produced by means of reforming of fossil fuels with CO₂ emission it does not solve the problem of greenhouse gas emission (GES);

transmission and distribution require infrastructure which is connected with significant expenditures. There is also an unsolved problem of safety regulations related to hydrogen;

built-in storage is also a major restriction due to small volumetric density of hydrogen. Solutions that are being considered are connected with safety issues (high pressure) or complexity (hydrides).

Therefore, there is an obvious need to develop simplified technical and technological solutions that enable use of hydrogen as an energy carrier to power integrated systems and others.

Common petrol stations are equipped with underground petroleum-based fuel storage tanks and operating stations and fuel dispensers. Some petrol stations are also equipped with the liquefied petroleum gas (LPG) dispensers. Customers i.e. mechanical vehicle drivers fill in their tanks with required quantity of petrol or liquefied petroleum gas (LPG) and read the unit price, fuel volume filled and the price for fueling to be paid on a display.

Fast development of search and production of alternate fuels, as well as new technologies of their use result in dynamic development of alternate fuel applications for electric energy generation but, first of all, as alternate fuels in road and rail transport that use internal combustion engines.

A Polish patent application No. PL 216476, “Method and system of producing pure hydrogen from fuel gas”, discloses a method of producing pure hydrogen from fuel gases in which the following components are used: steam and oxygen at a temperature between 5 and 1500° C. and fuel gas at a temperature between 5 and 300° C. of a general formula CₓH_{y}O_{z} where “x” and “y” are integers or fractions that are greater than 0, “z” is an integer or fraction that is greater than or equal to 0, and “x”, “y” and “z” are limited by the C/O mole ratio amounting to 0.5 and C/H mole ratio between 0.12 and 0.8 in the entire mixture. Steam and oxygen at the above parameters are pumped to a catalytic oxyforming reactor in which the pressure is maintained between 0.1 to 8 MPa and where the products of oxyforming in a form of H₂, H₂O, CO and CO₂ are obtained and then pumped to H₂ separation system in which the hydrogen is separated and the remaining components are supplied to the CO₂ separation system and then once CO₂ is removed the H₂O and CO mixture is returned to the inlet of the oxyforming reactor where it is mixed with a fresh stream of substrates. Separated hydrogen from the H₂ separation system feeds a fuel cell where the conversion of hydrogen into electric energy, which is partially used do supply an O₂ generation system, takes place. A catalytic oxyforming reactor is equipped with an automatic temperature regulation subsystem at the exit of the oxyforming reactor, which consists of a temperature controller as well as oxygen and steam flow controllers and is connected to the H₂ and CO₂ separation systems, whereas H₂ separation system is connected to the fuel cell which is connected to the O₂ generation system.

A European patent application No. EP 2288574, “System for the autonomous generation of hydrogen for an on-board system”, discloses a system for generating the hydrogen from material that contains a chamber for recovery of used material, by supplying energy. The disclosed embodiments relate to a hydrogen generation system or a hydrogen generator from material that is used as reagent, and the mentioned system contains recovery system for material that is used to generate the hydrogen in the on-board [integrated] system. The material is an oxide forming at least binary compound with oxygen. Characteristically oxide has form of porous material. According to this patent, materials such as porous oxides that have a large specific surface area favorably greater than or equal to 50 m²/g, which can even reach 1 500 m²/g, are used to increase the kinetics of H₂ and O₂.

A Polish patent application No. PL 214901, “Process of hydrogen production”, discloses a method of producing hydrogen based on water electrolysis. In this process, direct high voltage ranging from 0.8 kV to 30 kV from a high voltage source is introduced between the electrodes, cathode and anode, which are in water, and an additional electrode is introduced, which together with the cathode is connected to an impulse generator to generate impulse voltage ranging from 5 kV to 25 kV. Impulse voltage is a square, sine, sawtooth or relaxation wave.

A drawback of the solutions in the known state of the art is the fact that the hydrogen used to power cars is distributed at the specialized gas stations, less often at petrol stations due to the fact that it is produced in a centralized way by big chemical plants. Commercially available large-scale technologies of hydrogen production use fossil fuel both as a hydrogen source as well as a source of energy required for its production. Gas that is produced in such a way is of low purity and therefore requires purification which is a very expensive process. In case of central hydrogen fuel production plants the most vital problem is high cost of transporting the hydrogen to customers located even hundreds of kilometers away. Those inconveniences are solved by the disclosed embodiments.

### SUMMARY

The aim of the disclosed embodiments is to build a complete system of devices favorably integrated into a mobile container station intended for the production of pure hydrogen and for hydrogen distribution, solving a series of problems related mostly to the logistics and guarantee of safety during hydrogen fuel distribution.

A container station for producing hydrogen is built of a series of devices that enable production of high purity hydrogen in a gaseous form as a result of an electrochemical reaction. Furthermore, the container station for producing hydrogen is equipped with a system for hydrogen compression and storage in high pressure tanks in form of composite cylinders, as well as a module for direct refueling of cars with produced hydrogen which solves the series of current, technical problems described above known from the state of the art. Installation of an additional fuel cell in the container station for producing hydrogen also enables distribution of electric energy.

According to the disclosed embodiments the container station for hydrogen production and distribution is installed in the container whose base from the bottom side is equipped with stabilizing runners. Two longitudinal side walls and two front side walls are permanently fixed to the base and closed from the top with a roof. Connection of power network and/or a renewable energy source, container water feeding connection, inlet and outlet of central heating liquid as well as air inlet are installed on the outer side of front wall. A voltage converter, an air intake with filter and a shutter, an electrolyzer, a water filter connected to the electrolyzer and a fuel cell are installed inside the container. Electrolyzer is connected to the hydrogen distribution station by means of hydrogen pressure conduit. A hydrogen dryer, a hydrogen non-return valve, a hydrogen compressor, a second hydrogen dryer and a second hydrogen non-return valve are installed on the hydrogen pressure conduit on the electrolyzer side. High pressure hydrogen composite cylinders are connected to the hydrogen pressure conduit. In addition, the electrolyzer is connected to the fuel cell generating direct current (DC) using the oxygen pressure conduit. An oxygen dryer, an oxygen non-return valve, an oxygen compressor, a second oxygen dryer and a second oxygen non-return valve as well as an oxygen solenoid valve are installed on the oxygen pressure conduit on the electrolyzer side. High pressure oxygen composite cylinders are connected to the oxygen pressure conduit. Fuel cell is connected to the hydrogen pressure conduit using pressure conduit with the hydrogen solenoid valve. Inlet and outlet of central heating liquid are connected to the heat exchanger with fans, and the three-way valves of the cooling and heating system of central heating liquid are installed on the inlet and outlet of central heating liquid. Cooling and heating systems of central heating liquid are installed on the top outer surface of the roof on which an air exchange outlet duct with a fan and a damper is installed. Three-way valves of the cooling and heating system of central heating liquid are installed on the inlet and outlet of central heating liquid.

Favorably, the side walls and the roof are equipped with a series of openings and skylights.

Favorably, renewable energy sources such as photovoltaic cells or wind turbines and/or a rechargeable battery are the source of power supply of the container station for hydrogen production. Such solution enables efficient and effective use of electric energy generated from RES which is subject to significant output changes.

Electric energy provided from the power supply source to the container station for hydrogen production and distribution supplies the voltage converter which is favorably an AC/DC converter. The voltage converter is mounted between the electrolyzer and the power supply source. Voltage from the power supply source is introduced to the main circuit of the AC/DC converter and then as a direct current it is supplied to the electrolyzer producing the hydrogen and oxygen as a result of an electrolytic reaction, as well as to supply other equipment of the container station for hydrogen production and distribution.

The nature of the new construction of the electrolyzer is division of an electrolytic tank into two electrolytic compartments positioned horizontally side by side where the cathode is installed in one of the electrolytic compartments and the anode in the other one. The construction of the electrolytic tank enables a two-way flow of electrolyte between the electrolytic cathode compartment and the electrolytic anode compartment.

According to the disclosed embodiments the process of producing hydrogen (H₂) in a form of pure gas in the electrolyzer is based on the process of low temperature electrolysis of previously purified water. The electrolysis unit contains a cathode pack and an anode pack, and the electrolytic tank that is divided into two parts. Depending on the variant, the low temperature electrolysis of water is carried out in the electrolyzer that is based on the electrolysis in the alkaline environment using separating membrane or a plate electrolyzer using plates of electrode packs made of various metals or their alloys. Favorably, the plates of electrode packs made of various metals or their alloys have side wall surfaces coated with porous carbon material. Favorably, the plate of an electrode pack is made of graphene.

According to the disclosed embodiments, the electrolyzer for producing hydrogen and oxygen consists of a bottom cover which is also a bottom and external walls of an electrolyte tank as well as an upper cover in form of two domes equipped with hydrogen and oxygen pressure sensors. Two domes are permanently and tightly connected at their bottom middle part by a tank partition which is permanently fixed to the opposite side walls above the bottom of the electrolyte tank and divides the electrolyte tank into two compartments: the electrolytic cathode compartment and the electrolytic anode compartment. A cathode pack with a power cord is installed in the electrolytic cathode compartment. An anode pack with a power cord is installed in the electrolytic anode compartment. The cathode pack and the anode pack consist of a metal core with a permanently fixed upper support bar and a bottom support bar on which a supporting structure of the cathode pack plates and the anode pack plates is mounted. Mounting strips with horizontal guides and vertical guides are fixed to the supporting structure and the cathode pack plates and the anode pack plates are positioned vertically and parallel to one another at equal distances. A strip connecting vertical guides is installed in the cathode pack and the anode pack at the around % of their height. The cathode pack plate and the anode plate consist of an enclosure made of a channel bar, inside of which there is a flat metal plate whose flat side surfaces have permanently fixed coatings and a lug with a hole is fixed to the enclosure made of the channel bar. A system for feeding the cathode pack with electrolyte consisting of pipe elements, a water pump and a cathode directional cup with an injector, as well as system for feeding the anode pack with electrolyte consisting of pipe elements, a water pump and an anode directional cup with an injector are installed in the electrolyzer. A hydrogen pressure conduit that connects the electrolyzer with the hydrogen distribution station is connected to an outlet port that is installed on the dome and the oxygen pressure conduit that connects the electrolyzer with the fuel cell is connected to the outlet port installed on the dome.

Favorably, the electrolytic tank is filled with water-based liquid electrolyte or is filled with water purified in the container's filter.

Favorably, the domes covering the electrolytic tank are semi-circular or cone-shaped or pyramid-shaped.

Partition installed in the electrolyte tank does not adjoin the bottom of the electrolyzer tank enabling the liquid in the electrolytic compartments to flow freely resulting in the process of continuous mixing of electrolyte in both compartments of the electrolytic tank.

Construction of the cathode pack and the anode pack is identical.

Each plate of the cathode pack and the anode pack is placed in the supporting structure of the electrode pack in the special guides, favorably made of metal channel bars. Those channel bars are permanently fixed to the mounting strip installed on the upper part of the electrode structure on its opposite sides. The guides in which the electrode pack plates are located are fixed to the bottom side of the supporting structure of the electrode pack as well as to its vertical walls.

Plates of the electrode pack are positioned in the guides parallel to one another at equal distance enabling free flow of water or other liquid electrolyte between the electrode pack plates. A horizontal strip connecting the guides mounted on the vertical walls of the supporting structure of the electrode pack is installed at each cathode pack and anode pack at around % of their height which ensures stability of the entire electrode pack structure.

Each plate of the electrode pack consists of a flat metal plate whose two side surfaces have permanently fixed coating, favorably made of porous carbon material. Coatings made of porous carbon material are favorably fixed using electroconductive adhesive. Favorably, the porous carbon material is graphene.

The flat metal plate of the electrode pack together with coatings fixed on both sides is tightly installed in the enclosure made of a channel bar to which a mounting lug of the electrode pack plate is permanently fixed to be used for mounting to the supporting structure of electrode pack. In the mounting strip of the electrode pack structure as well as in the mounting lug of the electrode pack plate there are holes that enable connecting those elements with screws.

Favorably, instead of electrode pack plates the cathode pack and the anode pack consist of one longitudinal strip of the electrode pack that is wound around a metal core so that a fixed distance enabling free flow of electrolyte is kept between them. The longitudinal strip of the electrode pack wound around the metal core is positioned between a top supporting plate of a wound electrode pack and a bottom supporting plate of a wound electrode pack in a top and a bottom spiral guide.

Two side surfaces of each electrode pack strip have permanently fixed coatings, favorably made of porous carbon material. Coatings made of porous carbon material are favorably fixed using electroconductive adhesive. Favorably, the porous carbon material is graphene.

There is a forced electrolyte circulation installed in the electrolyzer feeding the electrolytic compartments of the tank thus directly forcing the flow of electrolyte through the cathode pack and the anode pack.

Hydrogen bubbles produced as a result of electrolysis on the cathode pack and oxygen bubbles produced on the anode pack are accumulated on the dome that covers the electrolytic cathode compartment and the anode compartment as a result of intensive electrolyte flow. Through the port installed in the dome covering the electrolytic cathode compartment hydrogen is transported to the hydrogen pressure conduit connecting the electrolyzer with the hydrogen distribution station installed in the container. Through the port installed in the dome covering the electrolytic anode compartment oxygen is transported to the oxygen pressure conduit connecting the electrolyzer with the fuel cell installed in the container. A hydrogen pressure sensor is installed on the dome covering the electrolytic cathode compartment. An oxygen pressure sensor is installed on the dome covering the electrolytic anode compartment. A connector of liquid water-based electrolyte is installed on the outer front wall of the bottom part of the hermetic electrolytic tank.

According to the disclosed embodiments, there are two or more cathode packs and two or more anode packs installed in the electrolytic cathode compartment and the electrolytic anode compartment to increase the electrolyzer capacity. Two or more cathode packs and two or more anode packs are electrically connected in parallel to each other. Each of the multiple cathode packs and multiple anode packs is supplied by an electronic control and protection system.

Favorably, the plates or the strip of the cathode pack and plates or the strip of the anode pack are made of graphene.

Hydrogen in the electrolyzer installed inside the container station for hydrogen production and distribution is favorably produced by electrolysis from purified tap water. First, water undergoes purification process using mechanical and osmosis filters.

Reactions taking place in the electrolyzer are as follows:

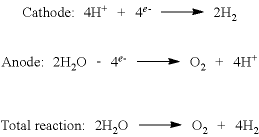

The above configuration of the system makes it possible to obtain gaseous hydrogen of high purity up to 99.99% H₂.

The container station for hydrogen production and distribution does not preclude the electrolyzers known from the previous state of the art to be installed inside the container.

Favorably, a PEM (Proton Exchange Membrane) electrolyzer with polymer proton exchange membrane or other known electrolyzer using electrolysis of water based fluid are used in the container station for hydrogen production.

Favorably, the electrolyzer is a PEM (Proton Exchange Membrane) electrolyzer or any other in which electrolyte is water based.

Favorably, composite high pressure cylinders holding up to 200 kg of gas are installed as storage tanks of hydrogen and oxygen inside the container and are connected to the hydrogen and the oxygen pressure conduits. Those cylinders enable storage of oxygen at the pressure of up to 80 MPa and hydrogen at the pressure of up to 120 MPa.

Compared to the currently used solutions the composite high-pressure cylinders are characterized by smaller hydrogen losses which enables its longer storage thanks to the use of series of polymer coatings and reinforcement of polymer matrix between other nanomaterials based on the carbon compounds. Those cylinders increase the safety of entire hydrogen production and storage system, as well as reduce the costs. Two gas pressure reduction units are connected to the composite hydrogen cylinders to enable its distribution. By using multi-stage pressure regulator those reduction units make it possible to reduce the pressure of gases collected from the cylinder down to outlet pressure of 70 MPa and 35 MPa and by means of control system ensure that the set pressure in the entire system is maintained automatically. Reduction units are equipped with safety and solenoid valves enabling automatic control by a digital controller of the control system.

A hydrogen distribution station for hydrogen powered motor vehicles consists of a digital gas flow meter, a digital controller and a reinforced flexible hose with a nozzle for refueling cars. The hydrogen distribution station enables refueling of cars that have gaseous fuel tanks from 0.1 MPa pressure. The hydrogen distribution station is equipped with a digital controller that monitors station operation. Favorably, the hydrogen distribution station for motor vehicles has a payment terminal installed.

Favorably, the hydrogen produced and stored in the cylinders is used to generate electric energy using a fuel cell. Oxygen required for the reaction is taken directly from the electrolyzer from the composite oxygen cylinder using reduction units.

In the disclosed embodiments, hydrogen is produced by electrolysis of tap water. First, water undergoes purification process using mechanical and osmosis filters. Low-temperature electrolysis of such prepared water, depending on the scenario, can be carried out at: an electrolyzer that is based on the electrolysis in alkaline environment using a separating membrane, a plate electrolyzer using various types of electrodes e.g. made of graphene, as well as an electrolyzer with a proton exchange membrane (PEM). If needed, produced hydrogen is purified and/or dried by an optional hydrogen purification system installed after the electrolyzer. Produced and separated gases (hydrogen and oxygen) are then compressed using compressor to separate tanks or pressure cylinders. It is favorable for this the disclosed embodiments to use hydrogen tanks that use metal hydrides and carbon materials.

Distribution system of the produced hydrogen fuel is based on the integrated refueling module that uses standard hydrogen connectors. In addition, the disclosed embodiments enables generation of electric energy from the produced hydrogen by means of a hydrogen fuel cell.

Operation of the container station for hydrogen production is monitored by a microprocessor controller provided with a computer program. It is also possible to monitor and control station's operation remotely using a GSM module. Furthermore, the container station is equipped with components that ensure its safe operation such e.g. safety valves, leakage and dangerous concentration detectors or temperature measurement. The entire control system is located in the container station for hydrogen production which is its additional advantage. Such solution results in its high mobility and enables relatively simple and fast installation e.g. when installing at the petrol station it does not require additional rooms. A precision air-conditioning system is an integral part of the disclosed embodiments responsible for maintaining optimum microclimate conditions i.e. humidity and temperature inside the container station for hydrogen production.

Favorably, the control system has a microprocessor that works with a computer program containing control strategy. Control strategy works in real time with a power supply stabilization system. Microprocessor has an operating system and a control program cooperating with the operating system in a form of a computer program which stores in its memory all resources for hydrogen production, electric energy generation based on hydrogen combustion as well as hydrogen storage and distribution systems. By having in its memory the resources of all data used that concern the analyzed area and catalogued summary tables of generated quality blocks the control program enables running a simulation of compiling blocks from models of quality parameters that meet quality parameters for specific cycles of hydrogen production. All the devices as well as connections of those devices installed in the container station for hydrogen production such as e.g. devices of a power supply and energy distribution system, a device for producing hydrogen by water electrolysis, a gas storage system, a hydrogen distribution system and a current generation system using a hydrogen cell are connected to the microprocessor. All those devices and their connections are connected to a single control system using an internal network picking up the impulses in real time of specific reactions during technological processes taking place in the container station for hydrogen production and distribution based on various forms of power supply.

According to the disclosed embodiments, the advantage of the container station for hydrogen production and distribution based on various forms of power supply is a several times lower cost of building a hydrogen refueling station compared to the currently used solutions, as well as production of very pure hydrogen without use of fossil fuels. Production of hydrogen on site, at a fuel distribution station, eliminates the costs of often long-distance transport and filling up the storage tanks resulting in the reduction of a number of specialist vehicles on the roads. Wide range of modernization options of the installed container station for hydrogen production as well as quick replacement of station devices independent of the season are also an advantage. Furthermore, the station operates in an automatic mode and does not require constant supervision. It has an option of remote monitoring of device's operation and station's internal connections with remote monitoring option. The advantage of the container station for hydrogen production and distribution according to the disclosed embodiments is also the fact that it is an integrated system for individual application in the household conditions as a device that eliminates classic electric power generators with internal combustion engines and other back-up power systems, especially in the households, such as UPS batteries and other back-up power systems without harmful emission of gases based on the silent operation of the station itself. The station facilitates storage of electric energy (in form of hydrogen) to be used independent of a commercial network, refueling vehicles and mobile hydrogen tanks in household conditions and production of hydrogen from RES as well as storage of hydrogen in the cylinders with minimum losses.

The container station for hydrogen production and distribution is intended, among others, as an extension of the existing petrol stations to expand their offer by hydrogen fuel, it increases their energy efficiency and is an additional or a primary individual electric power source supplying buildings such as e.g. detached single-family houses or agricultural facilities.

### BRIEF DESCRIPTION OF THE DRAWINGS

One of the embodiments of the container station for hydrogen production and distribution according to the disclosed embodiments is disclosed in a drawing, in which:

FIG. 1 shows a diagram of an example arrangement of devices installed inside and outside the station container and their connections;

FIG. 2 shows a block diagram of a container station power supply system;

FIG. 3 shows a block diagram of a control system;

FIG. 4 shows a diagram of the arrangement of sensors and relays of control system variables;

FIG. 5 schematically shows one of the examples of an electrolyzer construction

FIG. 6 schematically shows top and side views of an electrode pack;

FIG. 7 shows a cross section of an example plate of an electrolyzer electrode pack and its side view;

FIG. 8 shows a cross section of a strip of an electrolyzer electrode pack.

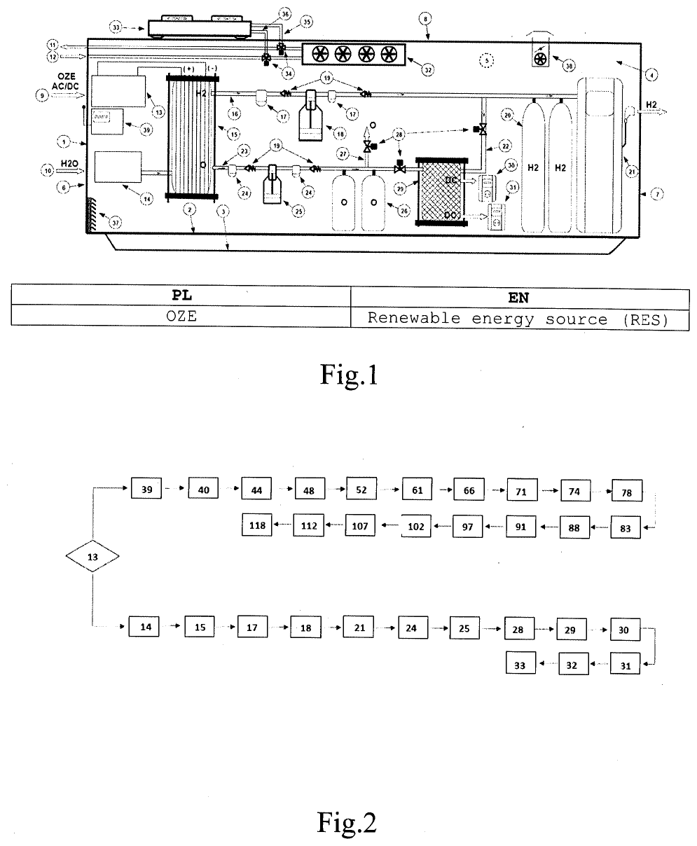

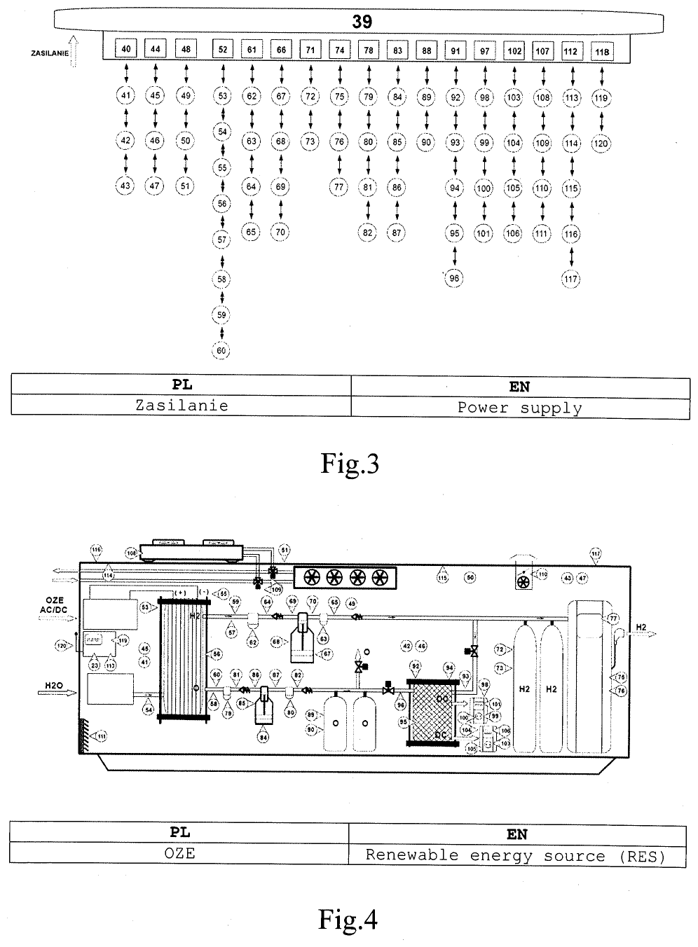

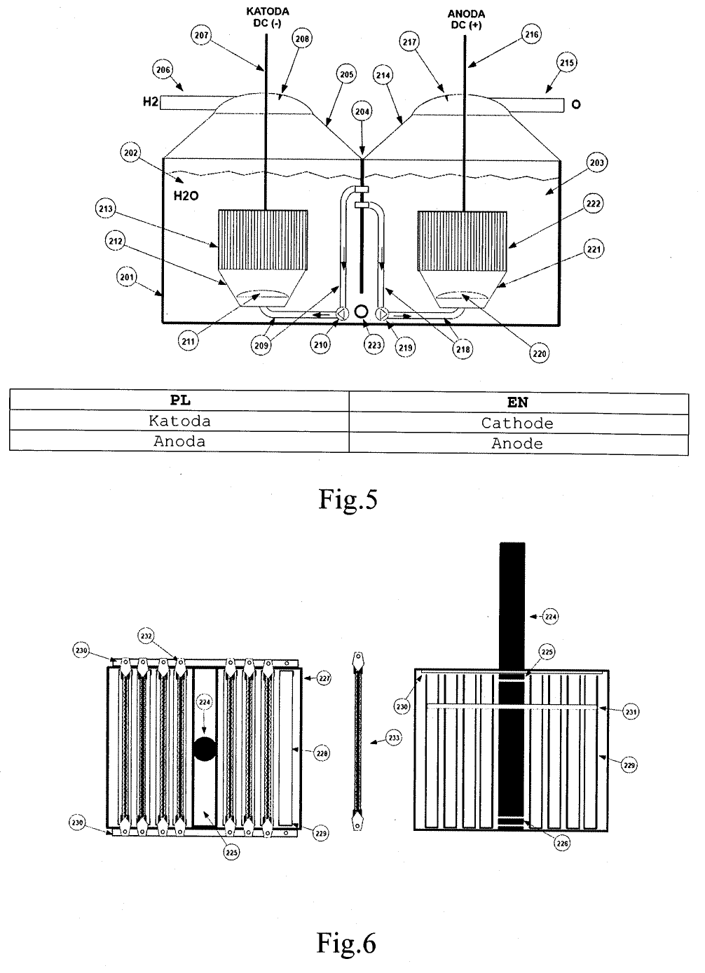

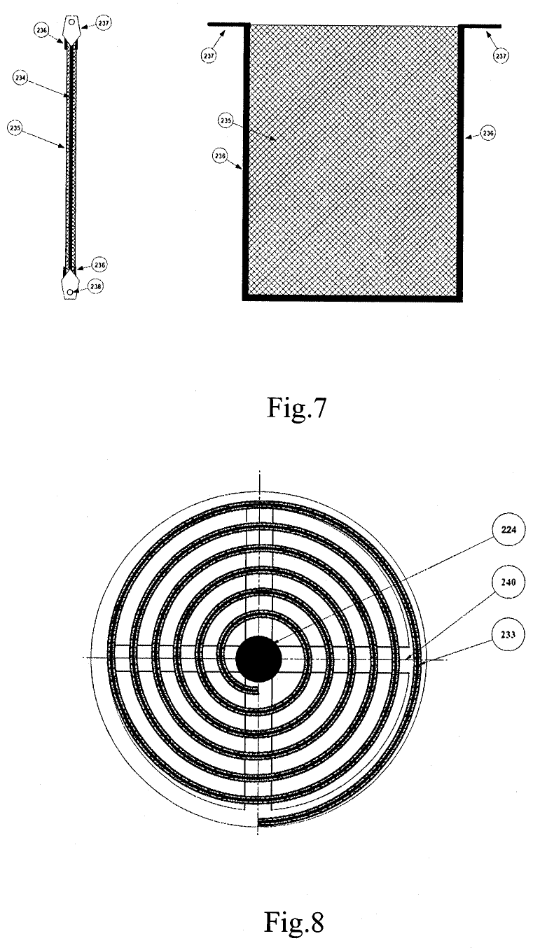

### BRIEF DESCRIPTION OF DISCLOSED EMBODIMENTS

An example container station for hydrogen production and distribution is installed in the container 1 whose base 2 from the bottom side is equipped with stabilizing runners 3. Two longitudinal side walls 4 and 5 and two front side walls 6 and 7 are permanently fixed to the base 2 and closed from the top with a roof 8. The side walls 4, 5, 6 and 7 and the roof 8 are equipped with a series of openings and skylights. Connection of power network 9 and/or a renewable energy source, connection 10 feeding the container 1 with water, inlet 12 and outlet 11 of central heating liquid as well as air inlet are installed on the outer front side of the wall 6.

A voltage converter 13, an air intake 37 with a filter and a shutter, an electrolyzer 15, a water filter 14 connected to the electrolyzer 15 and a fuel cell 29 are installed inside the container 1. The electrolyzer 15 is connected to the hydrogen distribution station 21 by means of a hydrogen pressure conduit 16.

A hydrogen dryer 17, a gas non-return valve 19, a hydrogen compressor 18, a second hydrogen dryer 17 and a second gas non-return valve 19 are installed on the hydrogen pressure conduit 16 from the electrolyzer 15 side. High pressure hydrogen composite cylinders 20 are connected to the hydrogen pressure conduit.

The electrolyzer 15 is connected to the fuel cell 29 generating direct current (DC) using the oxygen pressure conduit 23. An oxygen dryer 24, an oxygen non-return valve 19, an oxygen compressor 25, a second oxygen dryer 24 and a second oxygen non-return valve 19 as well as an oxygen solenoid valve 28 are installed on the oxygen pressure conduit 23 from the electrolyzer side 15. The solenoid valve 28 evacuating the oxygen generated in the electrolyzer is installed between the solenoid valve 28 and second non-return valve 19 on the oxygen line 27 to the oxygen pressure conduit 23. High pressure oxygen composite cylinders 26 are connected to the oxygen pressure conduit 23.

The fuel cell 29 is connected to the hydrogen pressure conduit 16 using pressure conduit 22 with hydrogen solenoid valve 28. Inlet 12 and outlet 11 of the central heating liquid are connected to the heat exchanger 32 with fans. The three-way valves 24 of the cooling and heating system 33 of central heating liquid are installed on the inlet 12 and the outlet 11 of central heating liquid.

The cooling and heating system 33 of the central heating liquid is installed on the top outer surface of the roof 8. An outlet duct 38 of air exchange with a fan and a damper is installed on the roof 8.

The electrolyzer 15 consists of a bottom cover 201 which is also a bottom and the external walls of the electrolyte tank 201 as well as an upper cover in form of two domes 205 and 214 equipped with gas pressure sensors 208 and 217 which are permanently and tightly connected at their bottom middle part by a tank 201 partition 204. The partition 204 is permanently fixed to the opposite side walls above the bottom of the tank 201 and divides the tank 201 into two compartments: the electrolytic cathode compartment 202 and the electrolytic anode compartment 203.

Cathode pack 213 with a power supply cord 207 is installed in the electrolytic cathode compartment 202. Anode pack 222 with a power supply cord 216 is installed in the electrolytic anode compartment 203.

The cathode pack 213 and the anode pack 222 consist of a metal core 224 with a permanently fixed upper support bar 225 and a bottom support bar 226 on which a supporting structure 227 of the cathode pack and the anode pack plates 233 is mounted. Mounting strips 230 with horizontal guides 228 and vertical guides 229 are fixed to the supporting structure 227. The cathode pack and the anode pack plates 233 are positioned vertically and parallel to one another at equal distance in the guides 228 and 229. A strip 231 connecting vertical guides 229 is installed in the cathode pack 213 and the anode pack 222 at ¾ of their height.

The cathode pack plate and the anode pack plate 233 consist of an enclosure made of a channel bar 236 inside of which there is a flat metal plate 234 whose flat side surfaces have permanently fixed coatings 235. A lug 237 with a hole 238 is fixed to the enclosure made of a channel bar.

System for feeding the cathode pack 213 with water consisting of pipe elements 209, a water pump 210 and a cathode directional cup 212 with an injector 211 is installed in the electrolyzer 15.

System for feeding the anode pack 222 with water consisting of pipe elements 218, a water pump 219 and an anode directional cup 221 with an injector 220.

Hydrogen pressure conduit 16 that connects the electrolyzer 15 with the hydrogen distribution station 21 is connected to the outlet port 206 installed on the dome 205.

Oxygen pressure conduit 23 that connects electrolyzer 15 with the fuel cell 29 is connected to the outlet port 215 installed on the dome 214.

An exemplary power supply system of the container station for hydrogen production and distribution consists of a voltage converter 13 supplied from a power network and/or a renewable power source (RES). Voltage converter 13 supplies the control system 39, the water filter 3, the electrolyzer 15, the gas dryers 17 and 24, the hydrogen compressor 18, the oxygen compressor 25, the solenoid valves 28, the distribution station of gaseous hydrogen 21, the fuel cell 29, the electric car charging module 30 and the outlet module leading to the electric network 31.

An example control system of the container station for hydrogen production according to the disclosed embodiments consist of a digital controller 39, which, favorably, is a microprocessor with a computer program. The control system collects information in real time and sends it to the microprocessor. Sensors transmitting information about the status of individual elements of the container station for hydrogen production are installed on all the devices operating in the container station.

Control system collects information from the following subsystems: a hydrogen detection subsystem 40, an oxygen detection subsystem 44, an ambient temperature indication subsystem 48, an electrolyzer 15 control subsystem 52, a hydrogen dryers 17 subsystem 61, a hydrogen compressor 18 subsystem 66, a compressed hydrogen storage cylinder unit 20 subsystem 71, a hydrogen distribution station 21 subsystem 74, an oxygen dryers 24 subsystem 78, an oxygen compressor 25 subsystem 83, a compressed oxygen storage cylinder unit 26 subsystem 88, a fuel cell 29 subsystem 91, a subsystem 97 of electric car and electric equipment charging module 30, a subsystem 102 of the outlet module leading to the electric network 31, a subsystem 107 of the liquid cooling and heating system 33, a monitoring subsystem 112 and a GSM module subsystem 118.

The hydrogen detection subsystem 40 receives information transmitted by sensor No. I 41, sensor No. II 42 and sensor No. III 43.

The oxygen detection subsystem 44 receives information transmitted by sensor No. I 45, sensor No. II 46 and sensor No. III 47.

The ambient temperature indication subsystem 48 receives information transmitted by temperature sensor No. I 49 inside the container 1, temperature sensor No. II 50 inside the container 1.

The electrolyzer 15 control subsystem 52 receives information transmitted by an operating status sensor 53, a water feeding sensor 54, a sensor 55 of electrolyzer 15 voltage measurement and regulation unit, a sensor 56 of temperature inside the electrolyzer 15, a sensor 57 of hydrogen pressure after the electrolyzer 15, a sensor 58 of oxygen pressure after the electrolyzer 15, a sensor 59 of hydrogen temperature after the electrolyzer 15, a sensor 60 of oxygen temperature after the electrolyzer 15.

The hydrogen dryers' subsystem 61 receives information transmitted by operating status sensor No. I 62, operating status sensor No. II 62, sensor No. I 64 of pressure after the dryer 17, sensor No. II 65 of pressure after the dryer 17.

A subsystem 66 receives information transmitted by an operating status sensor 67, a hydrogen compressor 18 temperature sensor 68, a sensor 69 of hydrogen pressure at the hydrogen compressor 18 inlet, a sensor 70 of hydrogen pressure at the hydrogen compressor 18 outlet.

A subsystem 71 receives information transmitted by a temperature sensor 72 of high pressure hydrogen tanks 20, a pressure sensor 73 of high pressure hydrogen tanks 20.

A subsystem 74 receives information transmitted by a hydrogen refueling pressure sensor 75, a hydrogen refueling temperature sensor 76, and a sensor 77 of a filled hydrogen volume meter unit.

A subsystem 78 receives information transmitted by operating status sensor No. I 79, operating status sensor No. II 80, pressure sensor No. I 81 after the oxygen dryer 24, pressure sensor No. II 82 after the oxygen dryer 24.

A subsystem 83 receives information transmitted by an operating status sensor 84, a oxygen compressor 25 temperature sensor 85, a sensor 86 of oxygen pressure at the oxygen compressor 25 inlet, a sensor of oxygen pressure at the oxygen compressor 25 outlet.

A subsystem 88 receives information transmitted by a temperature sensor 89 of oxygen high pressure tanks 26, a pressure sensor 90 of high pressure oxygen tanks 26.

A subsystem 91 receives information transmitted by an operating status sensor 92, a sensor 93 of hydrogen pressure measurement and regulation at the entry of the fuel cell 29, a sensor 94 of measurement and regulation of the fuel cell 29 output voltage, a sensor 96 oxygen pressure measurement and regulation at the entry of the fuel cell 29.

A subsystem 97 receives information transmitted by an operating status sensor 98, a sensor 99 of output voltage measurement and regulation for the electric car charging module 30, a sensor 100 of temperature inside the electric car charging module 30, a sensor 101 of a consumed electric energy meter unit.

A subsystem 102 receives information transmitted by an operating status sensor 103, a sensor 104 of output voltage measurement and regulation for the output module leading to the electric network 31, a sensor 105 of temperature inside the output module leading to the electric network, a sensor 106 of a meter unit of the transmitted electric energy.

A subsystem 107 receives information transmitted by a sensor 108 of the measurement and regulation unit of cooling and heating system 33 operation, a sensor 109 of the three-way valve status of the cooling and heating system 34, a sensor 110 of the damper position of the air exchange outlet duct 38, a sensor 111 of the air intake 37 position

A subsystem 112 receives information transmitted by an internal recorder sensor 113, internal camera No. I sensor 114, internal camera No. II sensor 115, external camera No. I sensor 116, external camera No. II sensor 117. A subsystem 118 receives information transmitted by a sensor 119 of the GSM transmission and reception unit and by a GSM antenna sensor 120.

1. A container station for hydrogen production and
distribution based on various power supply forms where hydrogen production takes place in the electrolyzer by means of thermal and chemical decomposition of water and where a regulator of gas mass flow, a hydrogen storage tank and an oxygen storage tank are installed, whereas the container is mounted on stabilizing runners, characterized in that it is installed in the container whose base from the bottom side is equipped with the stabilizing runners, two longitudinal side walls and two front side walls and are permanently fixed to the base and closed from the top with a roof, in which the connection of power network and/or renewable energy source (RES), connection 10 feeding the container with water, an inlet of central heating liquid and an outlet of central heating liquid as well as an air inlet are installed on the outer front side of the wall (6) but a voltage converter, an air intake with a filter and a shutter, an electrolyzer, a water filter connected to the electrolyzer and a fuel cell are installed inside the container, and the electrolyzer is connected to the hydrogen distribution station by means of a hydrogen pressure conduit where a hydrogen dryer, a hydrogen non-return valve, a hydrogen compressor, a second hydrogen dryer and a second hydrogen non-return valve are installed on the hydrogen pressure conduit from the electrolyzer side and high pressure hydrogen composite cylinders are connected to the hydrogen pressure conduit, while the electrolyzer is connected to the fuel cell generating direct current (DC) and an oxygen dryer, an oxygen non-return valve, an oxygen compressor, a second oxygen dryer and a second oxygen non-return valve as well as an oxygen solenoid valve are installed on the oxygen pressure conduit from the electrolyzer side, and high pressure oxygen composite cylinders are connected to the oxygen pressure conduit but the fuel cell is connected to the hydrogen pressure conduit using the pressure conduit with the hydrogen solenoid valve whereas the inlet of central heating liquid and the outlet of central heating liquid are connected to the fluid exchanger with fans where the three-way valves of the cooling and heating system of central heating liquid are installed on the inlet and outlet of central heating liquid and the cooling and heating system of the central heating liquid is installed on the outer surface of the roof on which the outlet duct of air exchange with a fan and a damper is installed and the station is equipped with a digital controller, which, favorably, is a microprocessor with a computer program installed.

2. The container station according to claim 1,
wherein, the hydrogen compressor compresses the hydrogen to the pressure up to 120 MPa.

3. The container station according to claim 1,
wherein the high pressure hydrogen composite cylinders store the hydrogen at the pressure range up to 120 MPa.

4. The container station according to claim 1,
wherein oxygen compressor compresses the oxygen to the pressure up to 80 MPa.

5. The container station according to claim 1,
wherein the high pressure oxygen composite cylinders store the oxygen at the pressure range up to 80 MPa.

6. The container station according to claim 1,
wherein the hydrogen high pressure storage tanks and the oxygen high pressure storage tanks are the high pressure hydrogen and oxygen composite cylinders
and holding up to 200 kg of gas, in which the oxygen is stored at the pressure range of up to 80 MPa and hydrogen is stored at the pressure range of up to 120 MPa.

7. The container station according to claim 1,
the solenoid valve evacuating the oxygen is installed between the solenoid valve and the second non-return valve on the oxygen line to the oxygen pressure conduit.

8. The container station according to claim 1, characterized
in that the voltage converter is installed between the electrolyzer a power supply source.

9. The container station according to claim 1,
wherein the oxygen from the high pressure composite cylinders for storing gaseous oxygen and the oxygen pressure conduit are vented to the atmosphere through the solenoid valve and the oxygen pressure conduit.

10. The container station according to claim 1,
wherein the electrolyzer consists of a bottom
cover which is also a bottom and the external walls of electrolyte tank as well as an upper cover in form of two domes and equipped with the hydrogen pressure sensor and the oxygen pressure sensor which are permanently and tightly connected at their bottom middle part by a tank partition and the partition is permanently fixed to the opposite side walls above the bottom of the tank and divides the tank into two compartments: the electrolytic cathode compartment and the electrolytic anode compartment where the cathode pack with a power supply cord is installed in the electrolytic cathode compartment and the anode pack with a power supply cord is installed in the electrolytic anode compartment, and the cathode pack and the anode pack consist of a metal core with a permanently fixed upper support bar and a bottom support
bar on which a supporting structure of cathode pack flat metal plates and anode pack plates is mounted and the mounting strips with horizontal guides and vertical guides are fixed to the supporting structure where the cathode pack flat metal plates and anode pack flat metal plates are positioned in the guides and vertically and parallel to one another at equal distance whereas the strip connecting vertical
guides is installed in the cathode pack and the anode pack at ¾ of their height but the cathode
pack plate and the anode pack plate consist of an enclosure made of a channel bar inside of which there is a flat metal plate whose flat side surfaces have permanently fixed coatings and a
lug with a hole is fixed to the enclosure made of a channel bar, in addition, a system for feeding the cathode pack with electrolyte consisting of pipe elements, a water pump and a cathode directional cup with an injector and the system for feeding the anode pack with electrolyte consisting of pipe elements, a water pump and an anode directional cup with an injector are installed in the electrolyzer, however, the hydrogen pressure conduit that connects the electrolyzer with the hydrogen distribution station is connected to the outlet port installed on the dome and the oxygen pressure conduit that connects
electrolyzer with the fuel cell is connected to the outlet port installed on the dome.

11. The container station according to claim 10,
wherein the cathode pack and the anode pack consist of a strip with coatings permanently fixed on both sides which is wound around a metal core between a top supporting plate of a wound electrode pack and a bottom supporting plate of a wound electrode pack in a spiral guide.

12. The container station according to claim 10,
wherein the system for feeding the cathode pack with the electrolyte sucks in the electrolyte from the upper part of the anode compartment and the system for feeding the anode pack with the electrolyte sucks in the electrolyte from the upper part of the cathode compartment.

13. The container station according to claim 10,
wherein the electrolyte is pure water or water based electrolytic fluid.

14. The container station according to claim 10,
wherein the coatings permanently fixed to the side surfaces of flat metal plate are made of porous carbon material.

15. The container station according to claim 10,
wherein porous carbon material is graphene.

16. The container station according to claim 1,
wherein the control system consists of a digital controller, which, favorably, is a microprocessor with a computer program that collects information in real time and sends it to the microprocessor in which the sensors transmitting information about the status of individual elements of the container station for hydrogen production are installed on all the devices operating in the container station but the control system is divided into a series of subsystems collecting information from the installed sensors.
